(19) United States
(12) Patent Application Publication
(10) Pub. No.: US 2013/0198621 A1
(43) Pub. Date: Aug. 1, 2013

(54) Document Tracking System and Method

(71) Applicants: Wyly Wade, Kingsland, TX (US); Mark Edward Gray, Alpharetta, GA (US)

(72) Inventors: Wyly Wade, Kingsland, TX (US); Mark Edward Gray, Alpharetta, GA (US)

(73) Assignee: BION ENTERPRISES, LLC, Atlanta, GA (US)

(21) Appl. No.: 13/600,431

(22) Filed: Aug. 31, 2012

Related U.S. Application Data
(60) Provisional application No. 61/529,336, filed on Aug. 31, 2011.

(51) Int. Cl. G06F 17/21

(52) U.S. Cl. CPC G06F 17/218
USPC 715/255

(57) ABSTRACT

A system and method is disclosed for modifying an origin document to create a tagged document, receiving a copy of a portion of a remote document, comparing the remote document portion with the tagged document and associating data on use of the remote document with the tagged document when the remote document portion includes a tag from the tagged document.

### RELATED APPLICATIONS

This application claims the benefit of U.S. Provisional Application No. 61/529,336 filed on Aug. 31, 2011, entitled DOCUMENT TRACKING SYSTEM AND METHOD and which is hereby incorporated in its entirety by reference.

### BACKGROUND

The present invention relates to tracking of electronic files, and in particular, tracking of electronic files across multiple computer systems.

Watermarks for protecting copyrighted material have existed for years. The watermarks are largely found in the gaming, movie, and music industry. Document watermarking has typically been a visual tag that is applied by a word processing or other creation program that appears in the background of the document, such as behind the text. For example, a static word such as “DRAFT” or “CONFIDENTIAL” may appear as the watermark in a document.

These watermarking systems, however, are not very robust and are vulnerable to tampering and can only be detected through incidental encounters.

### SUMMARY

A system and method is disclosed for modifying an origin document to create a tagged document, receiving a copy of a portion of a remote document, comparing the remote document portion with the tagged document and associating data on use of the remote document with the tagged document when the remote document portion includes a tag from the tagged document.

An exemplary method includes modifying an origin document to create a tagged document by embedding at least one tag at a random location in the origin document and associating a script, with an algorithm, with the origin document. The script is configured to generate and transmit document use data. A copy of at least a portion of a remote document is received along with document use data characterizing use of the remote document portion. And, the remote document portion is compared with the tagged document to determine whether the remote document portion includes the at least one tag at the random location. The method also includes associating the document use data with the tagged document when the remote document portion includes the tag at the random location.

The method may also include storing the tagged document and the random location, such as on a database. Access may be provided to the tagged document by originators and users.

The document use data may include location data, opening data, user identification data, a number of opening data and/or any other data useful for characterizing the modification, location, condition and other uses of the tagged document.

The script may be further configured to generate and transmit the document use data in response to opening of the tagged document or some other triggering activity. For example, the script may be configured to generate and transmit the document use data in response to copying of the tagged document or movement of the tagged document.

Modifying the origin document may include embedding a plurality of tags at a plurality of random locations in the origin document.

Comparing may further include determining whether the remote document portion includes the plurality of tags at the plurality of random locations. And, the method may include characterizing an authenticity of the remote document based on a proportion of the plurality of tags at the plurality of locations in the remote document portion. Authenticity may be verified if the proportion is 100%, or some lower threshold depending upon the tolerance of the originating system.

Modifying the origin document may also include associating a digital signature with the origin document. For example, the digital signature may be inserted into the origin document in a visible or obscured space, or into a non-visible text box within the origin document. The digital signature and random location may be stored to some type of storage, such as a storage database.

The method may also include determining origin data associated with the origin document and associating the origin data with the tagged document. Also, the origin data may be associated with the remote document portion.

The script, for example, may be COM or .NET object configured to call a server conducting the method and transmit a unique code associated with the tagged document to the server. This unique code may then be associated with the tagged document and with document use data for the tagged document.

The method may also include generating a random value for the tag, such as a noise value. The random location may also be generated from a noise value. The random value may also be a character, such as a space, a character switch, such as a number change or a format change. The format change, for example, may be a case change.

The document use information received from the users may include a requestor information, a tag locator number, an IP address, an operating system, a browser type, an operating system version, an application version, a date-time stamp or an internal IP address. The method may also include adding a GeoIP tag to the IP address to facilitate determination of a geographical location of the tagged document.

The method may also include repeatedly receiving document use information and storing the document information in a historical file associated with the tagged document. Also, a report may be generated that contains data from the historical data file, such as location data associated with the tagged document.

A report may also be generated of the document use data. The reports may be generated based on some trigger. For example, the method may include generating a report in response to the document use data including remote document location data outside of a predetermined geography. Or, the report may be generated in response to the document use data including a total number of uses exceeding a predetermined number of uses. Reports may also be generated in response to the document use data including an access by a user not having a predetermined clearance. Also, the report may be generated in response to the document use data including an access time outside of a predetermined access time range.

A system of the present invention, such as a computer system, as well as a computer program product with a plurality of functional modules, may be configured to implement the methods described above.

### BRIEF DESCRIPTION OF THE SEVERAL VIEWS OF THE DRAWINGS

FIG. 1 is a schematic of system for tracking documents;

FIG. 2 is a schematic of the system for tracking including interactions with origin systems and user systems; and

FIG. 3 is a schematic of a distributed computer system for tracking documents.

### DETAILED DESCRIPTION

With reference now to the figures, embodiments of the present invention include a system and method for modifying an origin document to create a tagged document, receiving a copy of a portion of a remote document, comparing the remote document portion with the tagged document and associating data on use of the remote document with the tagged document when the remote document portion includes a tag from the tagged document.

Uses and advantages of the system and method include government agency and businesses being able to track document transfers outside of an organization to ensure limited access only by appropriate persons.

The data room industry, which has developed to meet the needs of organizations that share large volumes of documents for corporate transactions, compliance, audits, procurement, litigation and other mission critical document exchange, can track use of the exchanged documents. For example, the system may report what electronic discovery documents were delivered, accessed and by whom, how often and when they were accessed or used.

Sales organizations can track client or prospective client uses of documents containing offer information. For example, the system can determine when a customer has opened a presentation, brochure or web page. The novelty is that while there are tools to track the sending and receiving of email or web pages the invention tracks the actual opening of documents, presentations and brochures. This could enable timing of follow up and/or follow on offers. Marketing professionals can better evaluate and design marketing campaigns based on historical document use reports and statistics derived therefrom to gain unique customer insights. Similar to marketing professionals, the tracking feature may allow job-seekers to determine usage information associated with their resume. The job-seeker can determine when, where and how often their resume has been accessed or forwarded.

The system and method also have security advantages. The movement of sensitive data may be tracked in real-time to determine when and to where and two whom the data has been sent. Such analytics can also be archived and reported by the system and method.

The system and method may also be used with bank statements so that when the webpage is loaded onto the client computer the IP address and other identification information about that computer is revealed. Such location and identification information can be analyzed for security threats, such as origination from an “unusual” location or known malicious computer system.

Important legal documents and letters, such as cease-and-desist letters or electronic service of process may be tracked by the system and method alerting the system when the communication is opened, forwarded or re-read.

The system and method also have advantages in intellectual-property law enforcement, ensuring retention of trade secret information or tracking the use of copyrighted information for billing and/or enforcement purposes.

The system and method may also help with social media applications, allowing a photo distributor to see which relatives or friends have opened and forwarded photographs.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

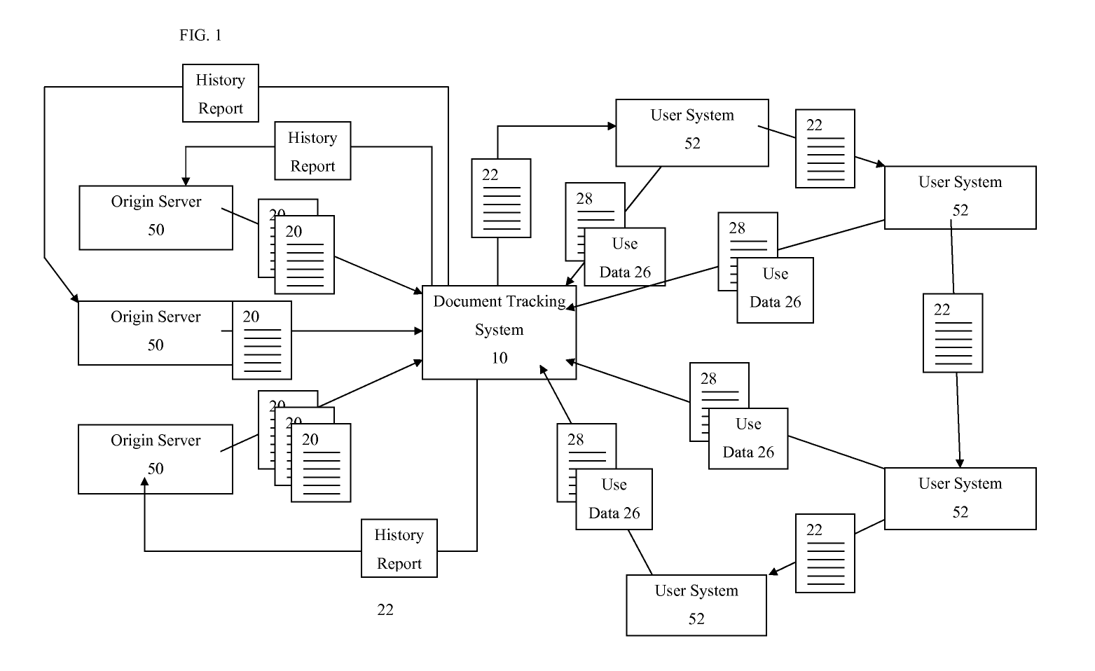

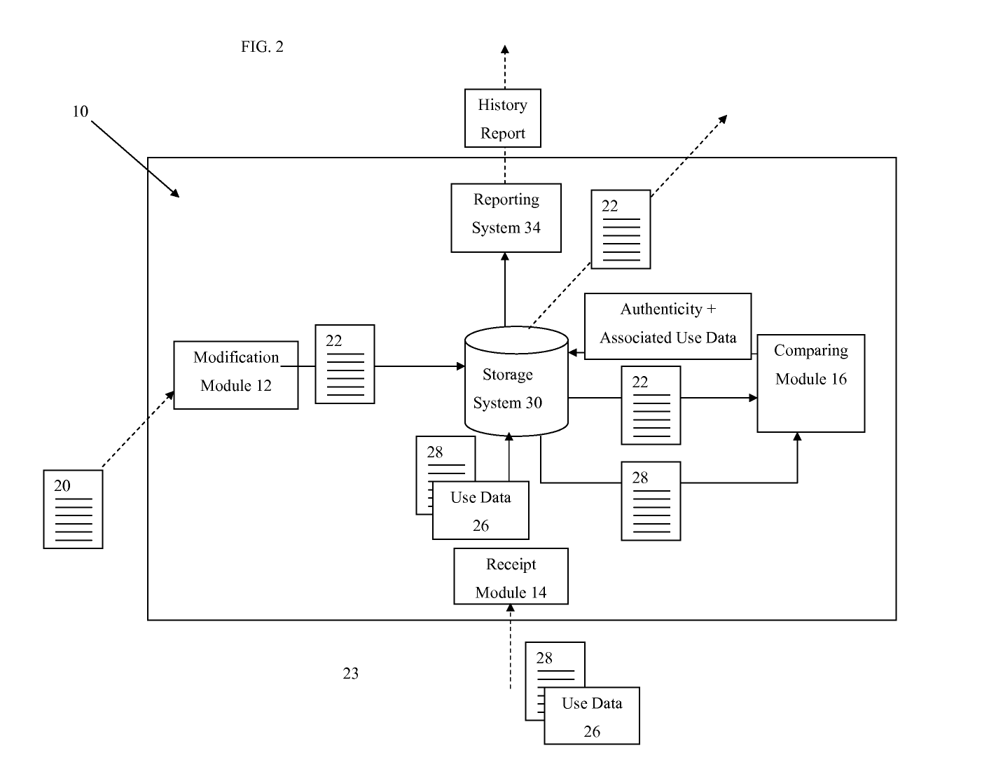

Referring now to FIG. 2, a system 10 for tracking documents is shown including a modification module 12, a receipt module 14, a comparing module 16, a storage system 30 and a reporting system 34. Interacting with the system 10 (and may also be part of the system 10) are an origin system 50 (or systems) and a plurality of user systems 52, as shown in FIG. 1. These origin system 50 has its origin documents 20 modified by the system 10 by the addition of tags 24 to produce tagged documents 22. The system 10 then allows distribution and use of the tagged documents 22 by the user systems 52 while continuously collecting use data 26 associated with the tagged documents 22.

The modification module 12 is configured to modify an origin document 20 to create a tagged document 22 by embedding at least one tag 24 at a random location in the origin document 20. Also, the modification module is configured to associate a script with the origin document 20, wherein the script is configured to generate and transmit use data 26 about the tagged document 20. The script could also be considered part of one or more of the tags.

The receipt module 14 is configured to receive a copy of at least a portion of a remote document 28. And, the receipt module 14 is configured to receive the use data 26 sent by the script from the tagged document 22. The use data 26 characterizes use of the remote document portion 28.

The comparing module 16 is configured to compare the remote document portion 28 with the tagged document 22 to determine whether the remote document portion includes the tag or tags 24. Also, the tags may be at random locations in the document to prevent detection and circumvention.

The term “document” as used herein to denote data collections in various forms—electronic and non-electronic—and includes all types of documents such as records, files, security information, computer programs, works of art, copyrightable and non-copyrightable information, data, government reports, military reports, computer programs, software documentation, instructions, lists, maps, customer information, formulas, trade secrets, photographs, etc., that start in the custody and control of a creating or acquiring entity that desires to track the location and/or use of such documents internally or externally to its own computer systems and facilities.

The term “script” refers to a code, program or other computer instruction that can be associated with the origin document 20. In some instances the script will be a short, hard to detect sequence of computer code to avoid detection and removal by third parties. The script may be configured to generate and transmit the document use data 26 to the receipt module 14 in response to opening of the tagged document 22. Also, the script may be configured to generate and transmit the document use data in response to copying of the tagged document 22. Further, the script may be configured to generate and transmit the document use data 26 in response to moving of the tagged document 22.

The term “tag” refers to uniquely generated code, data, words, images, pictures, formatting or other information or modification to the origin document 20 that allow for the originating entity (e.g., a company, government or person) to, when knowing of the tag's existence, systematically track the opening of a document, confirm the originator of the document and verify the authenticity of the document. Tags can be overt—clearly apparent to the user like a watermark—or covert, hidden from view or in unexpected (random) locations or forms, such as simple format modification. For example, transparent or white images could be used that blend into the background or a full image inside of a hidden text box.

The modification module 12 may be configured to embed a plurality of tags 24 at a plurality of random locations in the origin document 20. The modification module 12 may also be configured to associate a digital signature 32 with the origin document 20. For example, the digital signature 32 could be inserted into the origin document 20, such as into a visible or obscured space in the document. The visible or obscured space could be in an image in the document, such as a watermark, logo or letter head. A non-visible space could be a non-visible text box in the document. The digital signature 32 could also be inserted into a random location.

The comparing module 16 may be configured to determine whether the remote document 28 (or a portion thereof) includes one or more of the plurality of tags 24 at the plurality of locations. If a match is found, the document use data is associated with the tagged document 22.

Notably, in the case of the remote document 28 being only a portion of the tagged document 22 or a modified version of the tagged document, the plurality of tags 24 may be some subset of a larger number of tags with only some of those being the plurality of tags that survive various modifications by users and uses. In this instance, the comparing module 16 may be configured to characterize an authenticity of the remote document 28 based on a proportion of the plurality of tags 24 at the plurality of locations to the total number of tags 24 in the origin document 20. For example, authenticity can be 100% verified if 100% of the tags in the origin document 20 correspond to the plurality of tags 24 in the remote document 28.

The system 10 may also include a storage system 30 for storing the tagged document 22 and information about the random locations of the tags 24 in the document. The storage system 10 may also be configured to receive and store the document use data associated with the tagged document 22 by the comparing module 16.

The storage 30 and/or the system 10 may be configured, such as through a web portal, to provide access to the tagged document 22 for use such as reading, copying, forwarding and distribution. The storage system may also store origin data with the tagged document 22. This origin data may then be associated, such as by the comparing module 16, with the remote document portion 28. The origin data may include, for example, the original server 50 or entity owning or modifying the tagged document.

The receipt module 14 may also be configured to communicate with the storage system 30 for storing the document use data. Such document use data may include location, opening (including number of openings) and user identification data.

The script embedded in or associated with the tagged document 22 may be a COM or .NET object that is configured to call the system 10 and to transmit a unique code associated with the document to a server of the system 10. The comparing module 16 may be configured to associate the unique code with the tagged document 22. Further, the storage system 30 may be configured to store the document use data and the unique code together in association with the tagged document.

The modification module 12 may be further configured to generate a random value for the tags 24. For example, the random value and/or random location of the tag may be based on a noise value. The random value may also be a character, such as a space or a character switch. Character switches may include number, format or case changes.

Document use information is sent back to the receipt module 14 by the script embedded in the remote document 28 when it is a copy or portion of a tagged document 22. Such use information may include requestor information, a tag locator number, an IP address, an operating system, a browser type, an operating system version, an application version, a date-time stamp or an internal IP address, or any other information detectable and reportable by the script that has value to the document originating entity. The IP address is particularly useful when having a geo-location IP tag to allow determination of the current location and other details on the use of the remote document 28. IP address geo-location data can include information such as country, region, city, postal/zip code, latitude, longitude and time zone. Deeper data sets can determine other parameters such as domain name, connection speed, ISP, language, proxies, company name, US DMA/MSA, NAICS codes, and home/business.

The receipt module 14 may repeatedly receive document use information regarding the remote document 28 over time and can store the document use information in a historical data file associated with the tagged document. Such historical data files can be stored on the storage system 30, for example.

The system 10 may further include a reporting system 34 which is configured to generate a report containing document use data, such as data from the historical file. The report, for example, can contain location data associated with the tagged document 22 that shows where and when the document, or portions of the document, has been copied, distributed or used remotely. The reporting system 34 may be further configured to generate the report in response to the document use data including location data about the remote document that places it outside of predetermined geography, or a total number of uses exceeding some predetermined number, or access by a user without predetermined clearance or an access time outside of a predetermined access time range.

The system 10 for tracking documents has advantages for security and tracking purposes. Only the system originating the document will know which algorithm was used to generate the tags 24 and randomness in the placement of the tags. This makes it difficult for third parties to determine where and what part of the tagged document 22 is a tag versus a critical part of the document.

One advantage is the “randomness factor”—a document might have one tag that is attached to a logo along with N numbers of overt tags throughout the document at random locations. The fact that they are randomly placed makes detection of the tags 24 difficult unless the same document is available from two different sources. Even with an in-depth inspection, it will be hard to catch them all manually.

The tags 24 are active and unique to both the document and the downloader that is used to actively track the document and validate the documents authenticity. The system 10 and its tags 24 support the security matrix around confidential and secret data, protecting against leaks of protected and secret data in several ways. For example, the tags are active when the document is open and report back to the receipt module 14 of the system 10. The tags 24 are unique to the source of the tagged document 22 and therefore can be used to determine the origination point of the document. And, the tags 24 allow a verification of authenticity or a measure of authenticity based on the number of the tags in the remote document 28. Thus, the system 10 helps support the data security model with tracking, verification, and authentication of data.

A method of tracking documents includes the following steps:
1. Locate an origin document 20
2. Read through the origin document 20
3. Insert a first type of tag 24 to create a tagged document 22, including:
   a. Use a digital signature algorithm to generate a unique code for the tagged document 22
   b. Create a COM or .NET script (e.g., object) configured to call the server with the unique code attached
   c. Insert the object into one or more locations of the tagged document 22, such as in a visible space in an image or logo, an obscured space in the header or footer, or a non-visible text box in the document
   d. Store the locations and tag 24 in a storage system 30
4. Insert a second type of tag 24, including:
   a. Read through the tagged document 22
   b. Modify the tagged document 22 to create random changes and noise, such as adding single spaces at the end of sentences, changing a number from 100 to “one hundred” or changing a lower case letter to a capital letter
   c. Store the locations and tags 24 in the storage system 30, including 1 to N number of changes
5. Insert a third type of tag 24, including:
   a. Pick random locations within the tagged document 22
   b. Generate a unique digital fingerprint for the random locations
   c. Store the locations and digital fingerprints to the storage system 30

Random placement of the tags, and storage of those tags and locations for future reference, dramatically enhances security of the tagged document 22. Conventional tags are defined and placed within files at fixed locations and so can be more easily identified and removed. The system 10 is configured to quickly—in real time—retrieve and compare the tags and associated location data to received information about remote documents 28.

Another method or additional steps of tracking documents include:
1. Opening the tagged document 22
2. Calling the system 10, such as the receipt module 14
3. Recording, with the receipt module 14, information about the request, such as:
   a. Tag locator number
   b. IP address
   c. Operating system and version
   d. Browser type
   e. Application version
   f. Date/time
   g. Internal IP address
4. System 10 returns a tag 24, such as an invisible image, in response to calling of the system and/or recording
5. Associate the IP address with a geographical location (GeoIP tag the IP address)
6. Generate a report, with the reporting system 34, showing history of the movement of the tagged document 22

While tracking to document confirms opening of the document it does not confirm the authenticity or that the document has not been modified. Another method or additional steps of tracking documents includes an authentication process:
1. The remote document 28 (or portion thereof) is submitted to the comparing module
2. The tags 24 are identified and confirmed to be valid
3. The tags 24 are then again validated off of their various correspondence to stored random locations
4. An authenticity score between 0% and 100% is reported based on the fraction of the number of N changes remaining in the document
   a. For example, 8 of 10 changes would be an 80% (likely) chance that the remote document 28 is a copy of the tagged document 22, or if only 3 in 10, then a 30% (less likely) chance

Authenticity has the advantage of detecting tag swapping. Tag swapping is the process of cutting and pasting one document over another, preserving the original tag but with a different text. Such tag swapping would be detected by the authentication process.

Another advantage is that authenticity tags will survive format changes to documents, unlike conventional document tracking systems. For example, switching to text-only format, or a general format conversion, may result in a loss or removal of conventional tags. The system 10 of the present invention allows tracking regardless of the means of communication. Printing out of documents and later scanning would preserve the randomly placed authenticity tags 24, which could later be detected and verified by the system 10.

Another method or additional steps of tracking documents include a reporting process:
1. Detect a geographic location using processes described above
2. Compare geographic location to a criteria and respond with notification, including criteria such as:
   a. Access of document outside or inside a specific geography (e.g., outside the U.S. or inside China)
3. Detection of usage characteristics using processes described above
4. Compare usages to a criteria and respond with a notification, including criteria such as:
   a. Total number of accesses reach a threshold
   b. Single source accesses exceed a threshold
   c. Access by a particular type of user (e.g., below director level) or at an internal location or division of a company (outside legal or accounting)
   d. Access by a different government department, e.g., DOJ accesses when only DOD is allowed
5. Compare usage to date and/or time criteria:
   a. Document to only be viewed at certain times or within a certain period prior to expiration

In another implementation, the remote or tagged document or file itself may be configured to call “home” when it has been opened at the remote location. The remote document may include script or other logic associated with its electronic file that itself generates the report back to the rest of the system 10, such as by reporting back to the receipt module 14. Thus, reporting back is performed without any additional application on the computer on which the remote or tagged document resides and has been opened.

Advantages of reporting processes include the ability to not only track when and where a document is accessed, but its history of access. This provides a detailed chain of delivery of documents. The reporting system 34 is based on of what is considered normal access controls for physical security but new to document management. Thus, every tagged document and/or tag may have both reporting rules and escalation rules, based on legal, business, accounting and other standards.

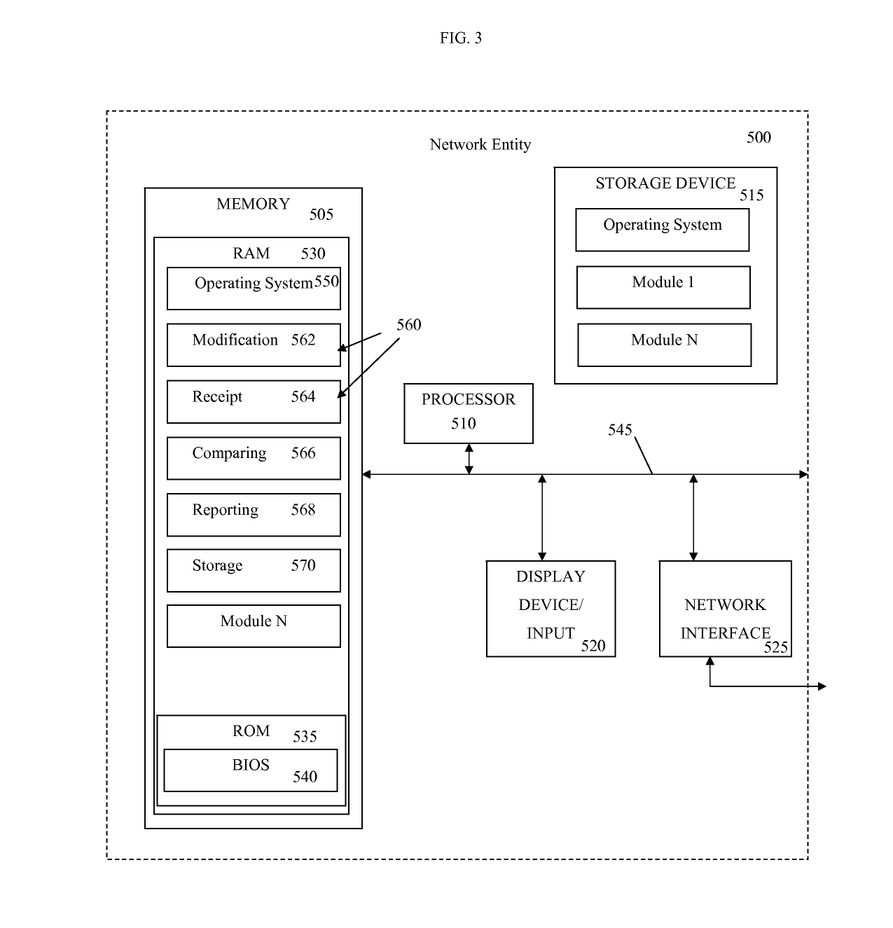

Referring now to FIG. 3, a schematic diagram of a central server 500, or similar network entity, configured to implement a document tracking system is provided. As used herein, the designation “central” merely serves to describe the common functionality the server provides for multiple clients or other computing devices and does not require or infer any centralized positioning of the server relative to other computing devices. As may be understood from FIG. 7, in this embodiment, the central server 500 may include a processor 510 that communicates with other elements within the central server 500 via a system interface or bus 545. Also included in the central server 500 may be a display device/input device 520 for receiving and displaying data. This display device/input device 520 may be, for example, a keyboard or pointing device that is used in combination with a monitor. The central server 500 may further include memory 505, which may include both read only memory (ROM) 535 and random access memory (RAM) 530. The server's ROM 535 may be used to store a basic input/output system 540 (BIOS), containing the basic routines that help to transfer information across the one or more networks.

In addition, the central server 500 may include at least one storage device 515 (or no storage device in the case where the computer is running off of cloud storage or a memory grid where the storage is shared), such as a hard disk drive, a floppy disk drive, a CD Rom drive, or optical disk drive, for storing information on various computer-readable media, such as a hard disk, a removable magnetic disk, or a CD-ROM disk. As will be appreciated by one of ordinary skill in the art, each of these storage devices 515 may be connected to the system bus 545 by an appropriate interface. The storage devices 515 and their associated computer-readable media may provide nonvolatile storage for a central server. It is important to note that the computer-readable media described above could be replaced by any other type of computer-readable media known in the art. Such media include, for example, magnetic cassettes, flash memory cards and digital video disks.

A number of program modules may be stored by the various storage devices and within RAM 530. Such program modules may include an operating system 550 and a plurality of one or more (N) modules 560. The modules 560 may control certain aspects of the operation of the central server 500, with the assistance of the processor 510 and the operating system 550. For example, the modules may perform the functions described above and illustrated by the figures and other materials disclosed herein. Exemplary modules include a modification module 562, a receipt module 564, a comparing module 566, a reporting module 568 and a storage module 570.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

1. A method comprising:
modifying an origin document to create a tagged document by embedding at least one tag at a random location in the origin document and associating a script with the origin document, the script configured to generate and transmit document use data;
receiving a copy of at least a portion of a remote document;
receiving document use data characterizing use of the remote document portion;
comparing the remote document portion with the tagged document to determine whether the remote document portion includes the at least one tag at the random location; and
associating the document use data with the tagged document when the remote document portion includes the at least one tag at the random location.

2. A method of claim 1, further comprising storing the tagged document and the random location.

3. A method of claim 2, further comprising providing access to the tagged document.

4. A method of claim 1, wherein the document use data includes location data.

5. A method of claim 4, wherein the document use data includes opening data.

6. A method of claim 5, wherein the document use data includes user identification data.

7. A method of claim 6, wherein the document use data includes a number of openings.

8. A method of claim 1, wherein the script is configured to generate and transmit the document use data in response to opening of the tagged document.

9. A method of claim 1, wherein the script is configured to generate and transmit the document use data in response to copying of the tagged document.

10. A method of claim 1, wherein the script is configured to generate and transmit the document use data in response to moving of the tagged document.

11. A method of claim 1, wherein modifying includes embedding a plurality of tags at a plurality of random locations in the origin document.

12. A method of claim 11, wherein comparing includes determining whether the remote document portion includes the plurality of tags at the plurality of random locations.

13. A method of claim 12, further comprising characterizing an authenticity of the remote document based on a proportion of the plurality of tags at the plurality of locations in the remote document portion.

14. A method of claim 13, wherein characterizing the authenticity includes verifying authenticity if the proportion is 100%.

15. A method of claim 1, wherein modifying the origin document to create the tagged document includes associating a digital signature with the origin document.

16. A method of claim 15, wherein associating the digital signature includes inserting the digital signature into the origin document.

17. A method of claim 16, wherein inserting the digital signature includes inserting the digital signature into a visible space.

18. A method of claim 16, wherein inserting the digital signature includes inserting the digital signature into an obscured space.

19. A method of claim 16, wherein inserting the digital signature includes inserting the digital signature into a non-visible text box within the origin document.

20. A method of claim 16, further comprising storing the random location and the digital signature.

21. A method of claim 1, further comprising determining origin data associated with the origin document and associating the origin data with the tagged document.

22. A method of claim 21, further comprising associating the origin data with the remote document portion.

23. A method of claim 1, wherein the script is a COM or .NET object and is configured to call a server conducting the method of claim 1 and transmit a unique code associated with the tagged document to the server.

24. A method of claim 23, further comprising associating the unique code with the tagged document.

25. A method of claim 24, further comprising storing the document use data and the unique code.

26. A method of claim 1, further comprising generating a random value for the tag.

27. A method of claim 26, wherein the random value is a noise value.

28. A method of claim 26, wherein the random location is a noise value.

29. A method of claim 28, wherein the random value is a character.

30. A method of claim 29, wherein the character is a space.

31. A method of claim 28, wherein the random value is a character switch.

32. A method of claim 31, wherein the character switch is a number change.

33. A method of claim 31, wherein the character switch is a format change.

34. A method of claim 33, wherein the format change is a case change.

35. A method of claim 1, wherein the document use information includes at least one of a requestor information, a tag locator number, an IP address, an operating system, a browser type, an operating system version, an application version, a date-time stamp or an internal IP address.

36. A method of claim 35, further comprising adding a GeoIP tag to the IP address.

37. A method of claim 1, further comprising repeatedly receiving document use information and storing the document use information in a historical data file associated with the tagged document.

38. A method of claim 37, further comprising generating a report containing data from the historical data file.

39. A method of claim 38, wherein the report contains location data associated with the tagged document.

40. A method of claim 1, further comprising generating a report containing the document use data.

41. A method of claim 40, wherein generating the report is in response to the document use data including remote document location data outside of a predetermined geography.

42. A method of claim 40, wherein generating the report is in response to the document use data including a total number of uses exceeding a predetermined number of uses.

43. A method of claim 40, wherein generating the report is in response to the document use data including access by a user not having a predetermined clearance.

44. A method of claim 40, wherein generating the report is in response to the document use data including an access time outside of a predetermined access time range.
